(19) United States
(12) Patent Application Publication
(10) Pub. No.: US 2007/0025592 A1
(43) Pub. Date: Feb. 1, 2007

(54) Target-region detection apparatus, method and program

(75) Inventors: Hidenori Takeshima, Ebina-shi (JP); Takashi Ida, Kawasaki-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/387,070

(22) Filed: Mar. 23, 2006

(30) Foreign Application Priority Data
Jul. 27, 2005 (JP) 2005-217792

(51) Int. Cl. G06K 9/00

(52) U.S. Cl. 382/103

(57) ABSTRACT

Target-region detection apparatus includes unit receiving image frame, unit detecting a position of first target in the image frame, unit acquiring at least one combination of reference image as image of reference frame and a position of second target in the reference frame, unit selecting the reference frame from the combination, based on estimation criterion for reducing overlapping area of the first target and the second target, unit detecting from the reference frame at least one difference region in which pixel value of the selected reference frame included in the combination differs from pixel value of the image frame, unit specifying target region of the image frame, in which the first target exists, based on the difference region, and unit storing, as reference frame information, the image frame and the position of the first target in the image frame.

### CROSS-REFERENCE TO RELATED APPLICATIONS

This application is based upon and claims the benefit of priority from prior Japanese Patent Application No. 2005-217792, filed Jul. 27, 2005, the entire contents of which are incorporated herein by reference.

### BACKGROUND OF THE INVENTION

1. Field of the Invention

The present invention relates to a target-region detection apparatus, method and program for replacing the background region of an image with another image.

2. Description of the Related Art

A method for computing the difference between frames is known as a target detection technique (see, for example, Jpn. Pat. Appln. KOKAI No. 2000-082145). In this technique, an inter-frame difference is computed to acquire a target region, using previous frames. The technique is useful in roughly detecting the region of a moving target. For instance, if the technique is used, a region that includes both the target regions of the present frame and a reference frame can be acquired.

In the above technique for computing the difference between previous frames to acquire the region of a target, if the range of movement of the target within a given period is small, the difference may not be detected, and hence the region of the target may not be determined. Further, if an error occurs in one of the previous frames, the position of the target may not correctly be detected, since in the post frames, the target position is estimated based on erroneous information.

### BRIEF SUMMARY OF THE INVENTION

In accordance with an aspect of the invention, there is provided a target-region detection apparatus comprising: an input unit configured to receive an image frame; a position detection unit configured to detect a position of a first target in the image frame; a reference image acquisition unit configured to acquire at least one combination of a reference image as an image of a reference frame and a position of a second target in the reference frame; a reference-frame selection unit configured to select the reference frame from the combination, based on an estimation criterion for reducing an overlapping area of the first target and the second target; a difference-region detection unit configured to detect from the reference frame at least one difference region in which a pixel value of the selected reference frame included in the combination differs from a pixel value of the image frame; a target-region specifying unit configured to specify a target region of the image frame, in which the first target exists, based on the difference region; and a storage unit configured to store, as reference frame information, the image frame and the position of the first target in the image frame.

In accordance with another aspect of the invention, there is provided a target-region detection method comprising: receiving an image frame; detecting a position of a first target in the image frame; acquiring at least one combination of a reference image as an image of a reference frame and a position of a second target in the reference frame; selecting the reference frame from the combination, based on an estimation criterion for reducing an overlapping area of the first target and the second target; detecting from the reference frame at least one difference region in which a pixel value of the selected reference frame included in the combination differs from a pixel value of the image frame; specifying a target region of the image frame, in which the first target exists, based on the difference region; and storing, as reference frame information, the image frame and the position of the first target in the image frame.

### BRIEF DESCRIPTION OF THE SEVERAL VIEWS OF THE DRAWING

FIG. 1 is a block diagram illustrating a target-region detection apparatus according to an embodiment;

FIG. 2 is a flowchart illustrating the operation of the target-region detection apparatus of FIG. 1;

FIG. 3 is a view useful in explaining a method for positioning a template in accordance with the position of a target;

FIG. 4 is a view useful in explaining a method for detecting a target region using an inter-frame difference;

FIG. 5 is a view illustrating the case of three reference frames in which their respective targets are positioned at different positions;

FIG. 6 is a flowchart illustrating a method for detecting a target region based on the logical product of inter-frame differences, which is performed by the target-region detection apparatus of FIG. 1;

FIG. 7 is a view useful in explaining the detection method of FIG. 6; and

FIG. 8 is a flowchart illustrating a modification of FIG. 6.

### DETAILED DESCRIPTION OF THE INVENTION

A target-region detection apparatus, method and program according to an embodiment of the invention will be described in detail with reference to the accompanying drawings.

The target-region detection apparatus, method and program of the embodiment of the invention can acquire the region of a target even if the target moves only a little.

(Fundamental Idea of Invention and Explanations of Terms)

Firstly, the fundamental idea of the embodiment will be explained.

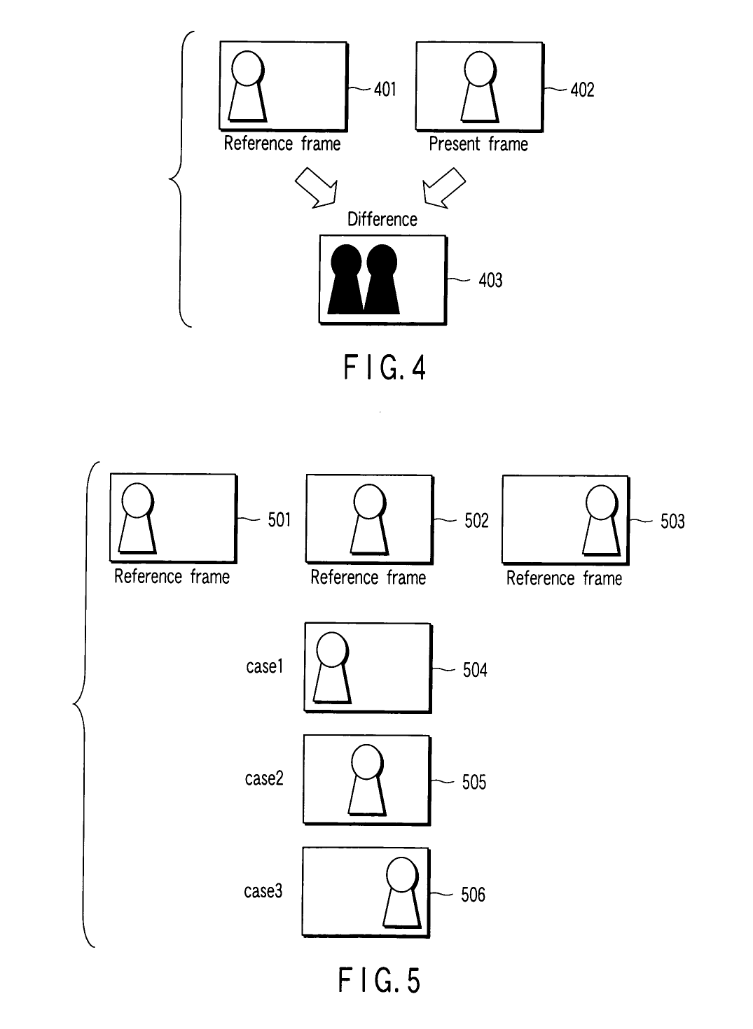

The inter-frame difference method is a method for computing, on the assumption that a target is positioned at different positions in different frames concerning an image of the target, the difference in a region between the present frame and a reference frame acquired several frames before the present frame, thereby acquiring the region of the target. Particulars will be described later with reference to FIG. 4. This method is useful only when the target moves, and not useful when the target does not move.

In light of the above, in the embodiment of the invention, the image acquired several frames before is not always used as the reference frame, but the reference image is selected from the previous frames so that the difference between the present frame and reference frame can always be acquired. To acquire the difference reliably, it is sufficient if a frame in which the position of a target (target position) is as far from the target position of the present frame as possible is used as the reference frame for difference computation. If a reference frame suitable for difference computation is selected, the target region can be acquired even if the target moves only a little. To easily realize the selection, the background difference method, in which a background image with no target is acquired beforehand and used as a reference frame, may be utilized.

However, if the background difference method is applied to, for example, an image acquired by a camera connected to a game machine or TV phone, a user (target) must move to a place where they are not captured by the camera, which makes them troublesome. To avoid this, a method could be employed, in which, for example, the middle value of previous several to several tens of frames is computed in units of pixels, and the resultant middle values are used as the components of a reference frame. However, if the target moves little in the previous several to several tens of frames, it cannot be detected.

To avoid this problem, it is necessary to select, from previous frames, a frame in which no target exists, and to use it as a reference frame. To realize this, for example, the position of a target in each frame is detected by some means, and reference-frame selection is performed based on the detected position. In the embodiment of the invention, reference-frame selection is performed based on this idea.

In the above detection technique, even if an error has occurred, it does not influence the results of detection performed after the occurrence of the error. Accordingly, in any frame after the occurrence of the error, the position of the target can be detected correctly, unlike the prior art.

(Configuration of Target-Region Detection Apparatus)

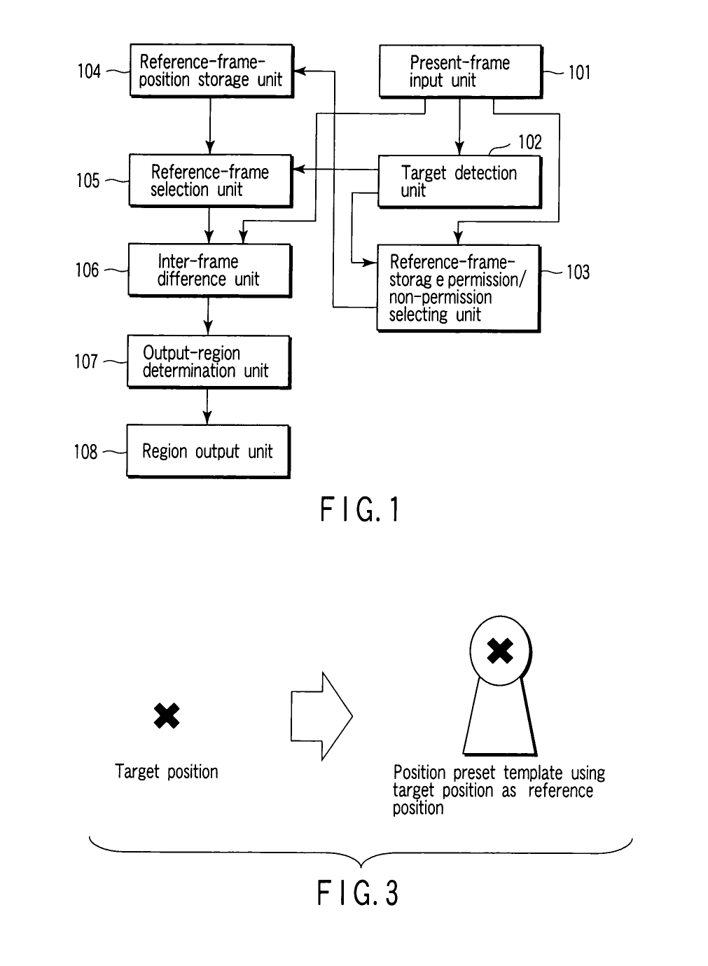

Referring to FIG. 1, the target-region detection apparatus of the embodiment will be described.

The target-region detection apparatus of the embodiment comprises a present-frame input unit 101, target detection unit 102, reference-frame-storage permission/non-permission selecting unit 103, reference-frame-position storage unit 104, reference-frame selection unit 105, inter-frame difference unit 106, output-region determination unit 107 and region output unit 108.

The present-frame input unit 101 receives, from a capture unit (not shown), the present image frame (present frame) acquired by capture. The capture unit captures a target and generates the present frame.

The target detection unit 102 applies a target detection method, described later, to the present frame output from the present-frame input unit 101, thereby acquiring the target position of the present frame. Depending upon the type of the target detection method, a plurality of target positions may be acquired. Various targets, such as a face, the entire body and a vehicle, can be used. However, smaller targets are desirable.

The reference-frame-storage permission/non-permission selecting unit 103 stores the present frame output from the present-frame input unit 101, and the target position(s) of the present frame detected by the target detection unit 102, for next et seq. frame processing. Namely, the stored frame and a target position thereof are used as a reference frame and a target position thereof in the next et seq. processes. If the reference-frame-storage permission/non-permission selecting unit 103 has a large memory capacity, it may store a large number of frames. Even if a large number of frames are stored, not so much time is required for processing, since the reference-frame selection unit 105 compares only the target positions of the reference and present frames.

Further, the reference-frame-storage permission/non-permission selecting unit 103 may determine by certain criteria whether each frame image should be stored, namely, may selectively store frame images. For instance, three reference frames with an image width of W are prepared, and it is determined whether the x-coordinates (horizontal coordinate) of the target positions of the reference frames are close to three reference points, x=0, W/2 and W. In this method, if the difference (horizontal distance) between the preset x-coordinate and the x-coordinate of the present frame is smaller than the difference (horizontal distance) between the preset x-coordinate and the x-coordinate of a reference frame, the reference frame is replaced with the present frame. Alternatively, two reference frames and two reference points, x=0 and W, may be prepared, and each reference frame may be replaced with the present frame in the same manner as the above. Further, reference coordinate points other than the above may be employed, or four or more reference frames may be used. Although the x-coordinate (horizontal coordinate) is employed as a reference coordinate in the above case, the y-coordinate (vertical coordinate) may be employed. In addition, the Euclid distance between the reference position (x, y) and the target position of the present frame may be used. The method, in which the distance to the reference position is utilized, is also effective to reduce the number of computations, since it does not require target detection, described later, performed in units of frames.

The reference-frame-position storage unit 104 stores the reference frame selected by the reference-frame-storage permission/non-permission selecting unit 103, and the target position of the reference frame. In general, the reference-frame-position storage unit 104 stores a plurality of reference frames and their target positions.

The reference-frame selection unit 105 selects, from the reference frames stored in the reference-frame-position storage unit 104, a reference frame suitable for acquiring the difference between itself and the present frame. The reference-frame selection unit 105 simultaneously acquires the reference frame and the target position of the reference frame. Further, the reference-frame selection unit 105 acquires the target position of the present frame from the target detection unit 102, and compares the target position of the reference frame with that of the present frame. When selecting a reference frame, the reference-frame selection unit 105 selects, for example, the reference frame having a target position at the maximum Euclid distance from the target position of the present frame. Further, when the reference-frame selection unit 105 acquires a plurality of target positions concerning the present frame from the target detection unit 102, it computes the Euclid distance between each target position of the present frame and the target position of each reference frame, thereby acquiring the minimum distance between each target position of the present frame and the target position of each reference frame. After that, the reference-frame selection unit 105 selects the frame whose acquired minimum distance is the greatest.

The inter-frame difference unit 106 computes difference regions between the reference frame selected by the reference-frame selection unit 105 and the present frame input by the present-frame input unit 101. There may be a single difference region or a plurality of difference regions. The region(s), in which the difference in the pixel value (e.g., the brightness or the color vector indicating a color of R, G or B) of each pixel between the present frame and the reference frame is not more than a preset threshold value, is set as a difference region (difference regions).

The output-region determination unit 107 determines a target region based on the acquired difference regions. The difference region(s) may be directly used as the target region. Alternatively, the output-region determination unit 107 may count the number of pixels contained in each of the acquired difference regions, and regard, as the target region, the difference region that contains not less than a preset number of pixels. Yet alternatively, the acquired difference region(s) may be subjected to filtering, such as dilation or erosion (see, for example, Jpn. Pat. Appln. KOKAI No. 2000-78564), thereby regarding, as the target region, the resultant difference region(s) having its noise reduced. Furthermore, the acquired difference region(s) may be compared with the target position acquired by the target detection unit 102, thereby regarding, as the target region, the region acquired by eliminating, from the difference region(s), the region in which no target exists.

The region output unit 108 outputs the target region determined by the output-region determination unit 107.

(Operation Example of Target-Region Detection Apparatus)

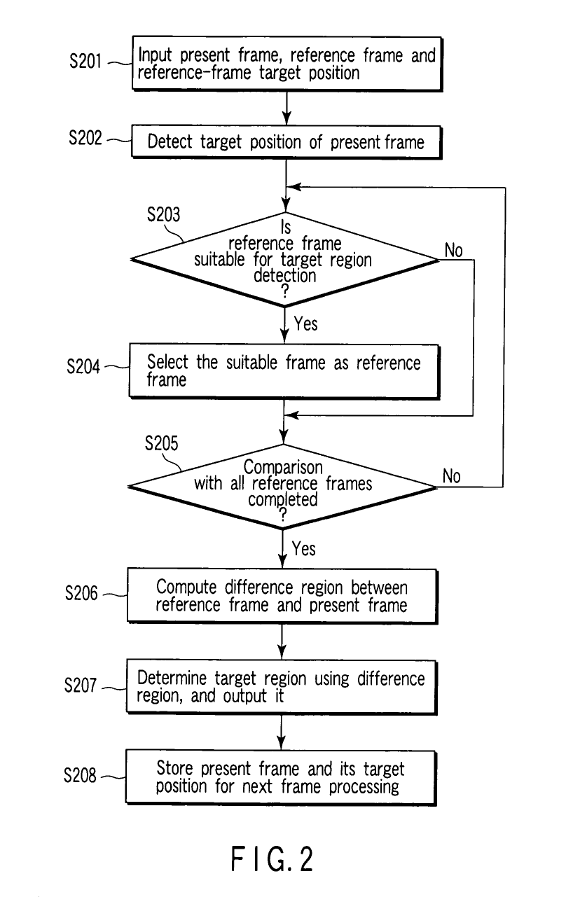

Referring now to FIG. 2, the operation of the target-region detection apparatus of FIG. 1 will be described.

The target-region detection apparatus of FIG. 1 performs the operation, described below, in units of frames. Before the operation, the reference-frame-position storage unit 104 stores at least one reference frame and its target position. Usually, the reference-frame-position storage unit 104 stores a plurality of reference frames and their target positions. If the reference-frame-position storage unit 104 stores three or more reference frames, the accuracy may well be enhanced. However, only a single reference frame may be stored. Further, one or more reference frames may be selected at random from the reference frames stored in the reference-frame-position storage unit 104. In general, the larger the number of frames, the higher the accuracy.

Firstly, the present-frame input unit 101 acquires the present image frame (present frame) acquired by, for example, capture (step S201). Subsequently, the target detection unit 102 acquires the target position of the present frame by applying a target detection method, described later, to the present frame (step S202). After that, the reference-frame selection unit 105 selects one from the reference frames prestored in the reference-frame selection unit 105, and determines whether the selected reference frame is suitable for the detection of the target position of the present frame (step S203). If it is determined that the reference frame is not suitable, the program proceeds to step S205, whereas if it is determined that the reference frame is suitable, the program proceeds to step S204.

The determination as to whether a certain reference frame is suitable for the detection of the target position of the present frame may be performed based only on the Euclid distance as described above. However, in a more generalized method, the determination is performed based on an estimation function E as below. For instance, the reference frame that minimizes the estimation function E may be selected. Alternatively, a certain threshold value Eth may be set, and all reference frames, which make the estimation function E lower than the threshold value Eth, be selected. The estimation function E is given by
E=α×t+β×size+γ×place
where t represents the time difference between the present frame and a certain reference frame, “size” represents the size of the target region of the present frame, and “place” represents the distance between a reference position and the target region of the present frame. The distance between the reference position and the target region is determined based on the Euclid distance. The difference between the target region of the present frame and that of the certain reference frame may be substituted for the size of the target region. In this case, the reference-frame-storage permission/non-permission selecting unit 103 also stores the size of each target. Further, the reference position is a preset reference position corresponding to the origin of the coordinates. For example, the position of the rightmost portion of an image may be used as the reference position. α, β and γ are certain preset values. In general, α>0, β>0, and γ<0.

Thereafter, if a certain reference frame makes the estimation function E lower than the threshold value Eth, the reference-frame selection unit 105 determines that the certain reference frame is suitable for the detection of the target region, and selects it (step S204). The reference-frame selection unit 105 then determines whether the determination at step S203 is completed concerning all reference frames prestored in the reference-frame-position storage unit 104 (step S2-5). If the determination is completed concerning all reference frames, the program proceeds to step S206, whereas if the determination is not yet completed concerning all reference frames, the program returns to step S203.

After that, the inter-frame difference unit 106 computes the difference region(s) between the selected reference frame and the present frame (step S206). In the case of difference-region computation using a single reference frame, each pixel value (e.g., an intensity level, such as a brightness level, or a vector indicating a color of R, G or B) of the present frame is subtracted from the corresponding pixel value of the single reference frame. If each subtraction result is not more than a preset threshold value, the corresponding pixel value is set as 1, and each pixel having the pixel value of 1 is assumed to be contained in the difference region.

Where a plurality of reference frames are selected, the inter-frame difference unit 106 computes the difference regions between the selected reference frames and the present frame in the same manner as the above. Subsequently, the inter-frame difference unit 106 sums up pixel values (1 or 0) acquired by the above subtraction process performed in units of pixels concerning all the selected reference frames. If the sum of the pixel values related to a certain pixel is not less than a threshold value, the unit 106 determines that the certain pixel is included in the difference regions. In contrast, if the sum is less than the threshold value, the unit 106 determines that the certain pixel is not included in the difference regions. Assume, for example, that there are 100 reference frames, and the threshold value is 60. In this case, the sum of the pixel values related to a certain pixel concerning all the selected reference frames is given, for example, by

1+0+1+1+ . . . +0 (the number of terms is 100)

If the sum is not less than 60, the certain pixel is contained in the difference regions.

Based on the difference regions acquired at step S206, the target region is determined and output (step S207). At step S207, the difference regions may be output as the target region. Alternatively, the number of pixels contained in each acquired region may be counted, thereby eliminating the regions that contain not more than a preset number of pixels. Yet alternatively, each acquired region may be compared with the target position detected at step S202, thereby eliminating the region(s) in which no target exists.

Lastly, for processing the subsequent frames, the reference-frame-storage permission/non-permission selecting unit 103 stores the present frame and the target position detected at step S202 (step S208).

(Target Detection Method Example)

A target detection method for detecting a known target will be described. As the target detection method, a template verification method is exemplified in which a template pattern indicating a target, such as a face or entire body, is prepared, and block matching or generalized Hough transform is performed. More specifically, as shown in FIG. 3, a template is positioned using the position of a target as a reference position. In the case of FIG. 3, a person is used as a target.

Many target detection methods are known. Ming-Hsuan Yang et al., “Detecting Faces in Images: A Survey,” IEEE Transaction on Pattern Analysis and Machine Intelligence, vol. 24, No. 1, January 2002 discloses several methods for detecting faces. Although the embodiment describes the example where target detection is performed in units of frames, selection and storage of reference frames may be performed in units of several frames. In this case, the lastly selected reference frame may be used while the selection is not performed, or reference-frame selection may be performed without using the position of a target. Accordingly, the number of times of target detection can be reduced. Further, the number of times of target detection can also be reduced if the distance from the reference position is utilized as described above.

(Inter-Frame Difference Method)

Referring to FIGS. 4 and 5, the inter-frame difference method will be described.

In the inter-frame difference method, the difference region 403 between the present frame 402 and a reference frame 401, which is included in reference frames wherein a target exists at different positions, is computed to acquire the region of the target as shown in FIG. 4. The difference region 403 contains both the target regions of the present frame and reference frame. This difference region can be acquired as long as the target exists at different positions between frames. However, if the target moves little, the inter-frame difference method is useless. In light of this, the reference-frame selection unit 105 must appropriately select reference frames to acquire the state shown in FIG. 4, instead of always using, as a reference frame image, the image acquired several frames before.

It is desirable that the reference-frame-storage permission/non-permission selecting unit 103 should store a plurality of reference frames of different target positions as shown in FIG. 5. In the examples of FIG. 5, targets (persons) exist at the left, center and right positions in the frames. In this case, the reference-frame-storage permission/non-permission selecting unit 103 stores reference frames 501, 502 and 503 corresponding to the left, center and right target positions, respectively. If the present frame is one of a frame 504 in which the target (person) exists at the left position, a frame 505 in which the target exists at the center position, and a frame 506 in which the target exists at the right position, one of the reference frames 501, 502 and 503 provides a difference region with respect to the present frame. Thus, if the reference-frame-storage permission/non-permission selecting unit 103 prestores such reference frames as shown in FIG. 5, the target (person) can be detected in all cases.

(Inter-Frame Difference AND Method)

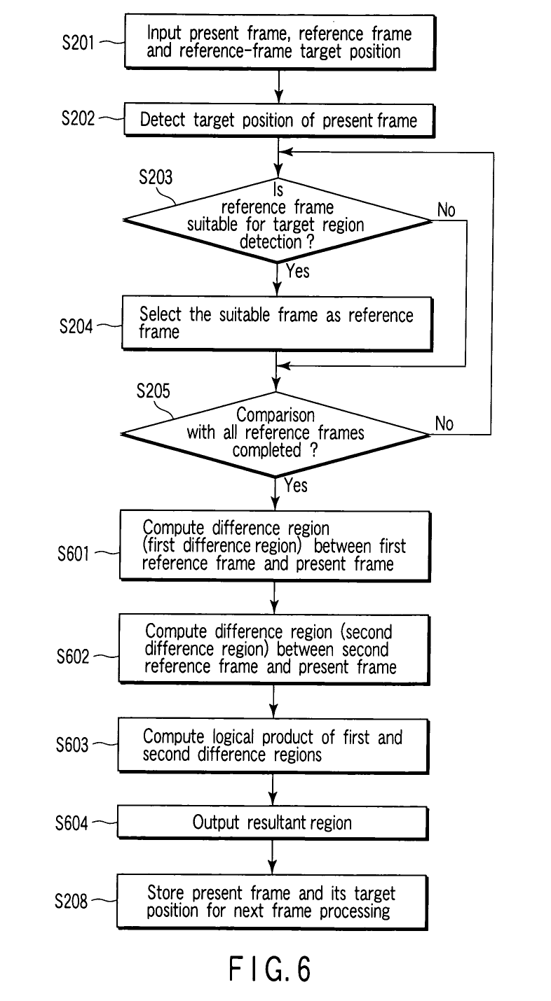

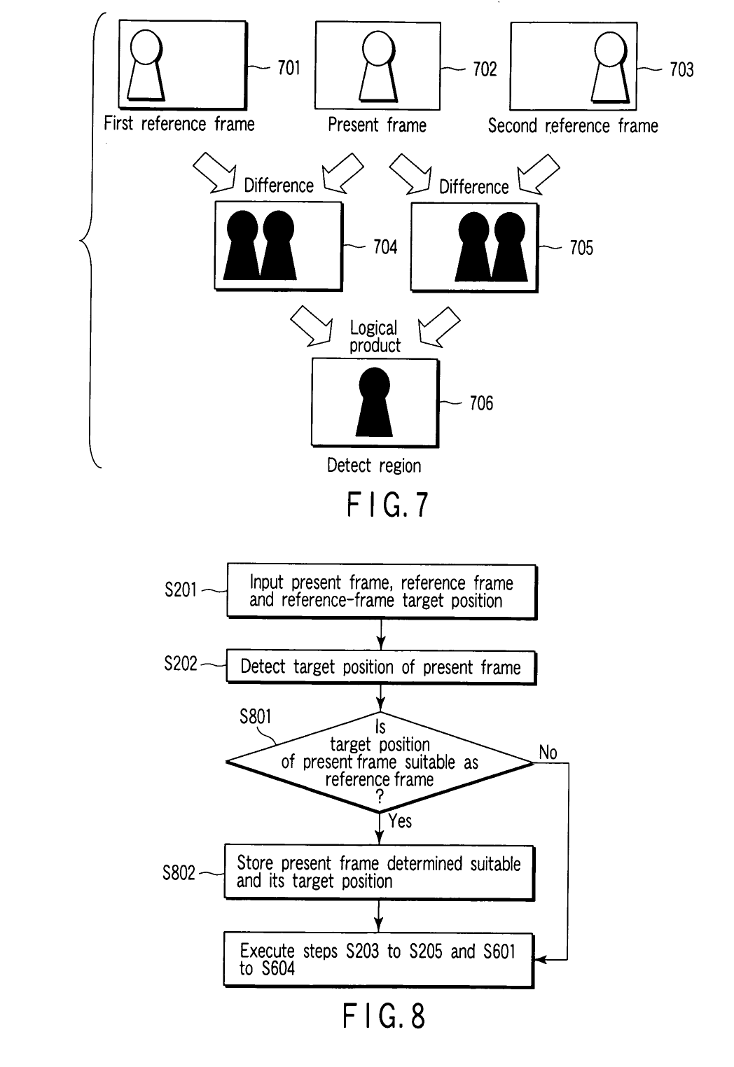

Referring to FIGS. 6 and 7, a description will be given of a method that utilizes the inter-frame difference and logical product. In this method, the following process is performed in units of frames. The reference-frame-storage permission/non-permission selecting unit 103 prestores two or more reference frames and their target positions. In the description below, the steps similar to the previously described ones are denoted by the corresponding reference numerals, and no description is given thereof.

At steps S203 to S205 in FIG. 6, reference-frame selection is performed as in the case of FIG. 2. In this case, however, the reference-frame selection unit 105 selects first and second reference frames in which the target exists at positions separate from each other. This selection is realized, for example, as follows. Firstly, the first reference frame is selected as in the same manner as at steps S203 to S205. Secondly, the second reference frame is selected to make maximum the shorter one of the distance between the target position of the present frame and that of the second reference frame, and the distance between the target position of the first reference frame and that of the second reference frame. As a result, such first and second reference frames 701 and 703 as shown in FIG. 7, between which the position of a target (person) differs, are selected.

At steps S601 and S602, the difference regions 704 between the first reference frame and the present frame, and the difference regions 705 between the second reference frame and the present frame are acquired as at step S206, and at step S603, the logical product 706 is acquired, as is shown in FIG. 7. At step S604, the resultant region is output. At step S604, the output-region determination unit 107 may output the difference region as a target region. If a plurality of difference regions are acquired by logical product computation at step S603, the output-region determination unit 107 may count the number of pixels contained in each acquired difference region, thereby setting, as the target region, the remaining region acquired by eliminating the regions that contain not more than a preset number of pixels. Alternatively, the acquired difference region(s) may be subjected to filtering, such as expansion or contraction (see, for example, Jpn. Pat. Appln. KOKAI No. 2000-78564), thereby regarding, as the target region, the resultant difference region(s) having its noise reduced. Furthermore, the acquired difference region(s) may be compared with the target position acquired by the target detection unit 102, thereby regarding, as the target region, the region acquired by eliminating, from the difference region(s), the region in which no target exists. Lastly, for processing the subsequent frames, the present frame and its target position are stored (step S208).

In the embodiment in which the inter-frame difference and logical product are utilized, step S208 may not always be performed lastly, but may be performed before step S203. This will be described with reference to the flowchart of FIG. 8.

At step S801, it is determined whether the present frame should be stored as a reference frame (if it is always stored, step S801 can be removed). If it is determined that the present frame should be stored, the present frame is stored as a reference frame at step S802. Also in the flowchart of FIG. 2, step S208 may be performed before step S203. In this case, steps corresponding to steps S801 and S802 are inserted before step S203, and step S208 is deleted.

(Application of this embodiment in which only face detection is performed in the initial stage, and when a reference frame is acquired, a template is replace with the reference frame)

An application of this embodiment will now be described. In this example, the above-described embodiment is utilized in a TV phone to replace an unnecessary background image with another prepared background image. In the above-described embodiment, it is assumed that one or more reference frames are prestored. However, in the TV phone, no reference frames exist immediately after the turn on of the phone. Accordingly, until a reference frame suitable for target-region detection is acquired, the target region cannot be correctly detected.

In the TV phone, it is very possible that the upper half body of a person is in the screen. Accordingly, a template of the upper half body of a person is prepared, the face of the person is detected as a target, and the template is positioned with reference to the position of the detected face, thereby acquiring a rough region of the target. This enables the target region to be detected even immediately after the turn on of the phone. Since the outline, for example, of the target acquired by template arrangement may well be misaligned, it may be corrected by the method disclosed in, for example, the non-patent document, Kass, A. Witkin and D. Terzopoulos, “Snakes: Active contour models,” International Journal of Computer Vision, vol. 1, No. 4, pp. 321-331, 1987, or the non-patent document, Takashi Ida and Yoko Sambonsugi, “Self-Affine Mapping System and Its Application to Object Contour Extraction,” IEEE Transaction on Image Processing, vol. 9, No. 11, November 2000. By the above-described method, the region of a target can be acquired even if the target moves little.

As described above, by selecting a reference frame suitable for difference-region computation, the region of a target can be acquired even if the target moves little.

The flow charts of the embodiments illustrate methods and systems according to the embodiments of the invention. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block of blocks. The computer program instructions may also be loaded onto a computer or other programmable apparatus to cause a series of operational steps to be performed on the computer or other programmable apparatus to produce a computer programmable apparatus provide steps for implementing the functions specified in the flowchart block or blocks.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A target-region detection apparatus comprising:
an input unit configured to receive an image frame;
a position detection unit configured to detect a position of a first target in the image frame;
a reference image acquisition unit configured to acquire at least one combination of a reference image as an image of a reference frame and a position of a second target in the reference frame;
a reference-frame selection unit configured to select the reference frame from the combination, based on an estimation criterion for reducing an overlapping area of the first target and the second target;
a difference-region detection unit configured to detect from the reference frame at least one difference region in which a pixel value of the selected reference frame included in the combination differs from a pixel value of the image frame;
a target-region specifying unit configured to specify a target region of the image frame, in which the first target exists, based on the difference region; and
a storage unit configured to store, as reference frame information, the image frame and the position of the first target in the image frame.

2. The apparatus according to claim 1, wherein the reference-frame selection unit acquires a distance between the position of the first target and the position of the second target, and selects the reference frame if the distance is greater than a threshold value as the estimation criterion.

3. The apparatus according to claim 1, wherein the reference-frame selection unit acquires a distance between the position of the first target and the position of the second target, acquires a difference in size between the first target and the second target, and selects the reference frame if a weighted sum of the difference and a value, acquired by multiplying the distance by a minus sign, is lower than a threshold value as the estimation criterion.

4. The apparatus according to claim 1, wherein the reference-frame selection unit selects from the combination at least one reference frame, in order of increasing overlapping area quantity.

5. The apparatus according to claim 1, wherein the reference-frame selection unit acquires a distance between the position of the first target and the position of the second target, and selects the reference image if the distance is maximum.

6. The apparatus according to claim 1, wherein:
when a first reference frame and a second reference frame similar to the reference frame included in the at least one combination exist, the reference-frame selection unit selects the first reference frame and the second reference frame;
the difference-region detection unit detects from the first reference frame at least one first difference region in which a pixel value of the first reference frame differs from the pixel value of the image frame, and detects from the second reference frame at least one second difference region in which a pixel value of the second reference frame differs from the pixel value of the image frame; and
the target-region specifying unit acquires a logical product region between the at least one first difference region and the at least one second difference region, and specifies the logical product region as the target region.

7. The apparatus according to claim 1, wherein the storage unit compares a distance between the position of the second target and a preset position with a distance between the position of the first target and the preset position, and stores the image frame and the position of the first target only if the position of the first target is closer to the preset position.

8. The apparatus according to claim 1, further comprising a target-region employing unit configured to employ a shape as a target region before acquiring the reference frame, the shape being preset using the position of the target as a reference position.

9. The apparatus according to claim 1, wherein the position detection unit detects a face or an upper part of a body to acquire the position of the target.

10. A target-region detection method comprising:
receiving an image frame;
detecting a position of a first target in the image frame;
acquiring at least one combination of a reference image as an image of a reference frame and a position of a second target in the reference frame;
selecting the reference frame from the combination, based on an estimation criterion for reducing an overlapping area of the first target and the second target;
detecting from the reference frame at least one difference region in which a pixel value of the selected reference frame included in the combination differs from a pixel value of the image frame;
specifying a target region of the image frame, in which the first target exists, based on the difference region; and
storing, as reference frame information, the image frame and the position of the first target in the image frame.

11. The method according to claim 10, wherein the selecting the at least one reference frame includes acquiring a distance between the position of the first target and the position of the second target, and selecting the reference frame if the distance is greater than a threshold value as the estimation criterion.

12. The method according to claim 10, wherein the selecting the at least one reference frame includes acquiring a distance between the position of the first target and the position of the second target, acquiring a difference in size between the first target and the second target, and selecting the reference frame if a weighted sum of the difference and a value, acquired by multiplying the distance by a minus sign, is lower than a threshold value as the estimation criterion.

13. The method according to claim 10, wherein the selecting the at least one reference frame includes selecting from the combination at least one reference frame, in order of increasing overlapping area quantity.

14. The method according to claim 10, wherein the selecting the at least one reference frame includes acquiring a distance between the position of the first target and the position of the second target, and selecting the reference image if the distance is maximum.

15. The method according to claim 10, wherein:
when a first reference frame and a second reference frame similar to the reference frame included in the at least one combination exist, the selecting the at least one reference frame includes selecting the first reference frame and the second reference frame;
the detecting from the first reference frame at least one difference region includes detecting at least one first difference region in which a pixel value of the first reference frame differs from the pixel value of the image frame, and detecting from the second reference frame at least one second difference region in which a pixel value of the second reference frame differs from the pixel value of the image frame; and
the specifying the target region of the image frame includes acquiring a logical product region between the at least one first difference region and the at least one second difference region, and specifying the logical product region as the target region.

16. The method according to claim 10, wherein the storing the image frame and the position of the target in the image frame includes comparing a distance between the position of the second target and a preset position with a distance between the position of the first target and the preset position, and storing the image frame and the position of the first target only if the position of the first target is closer to the preset position.

17. The method according to claim 10, further comprising employing a shape as a target region before acquiring the reference frame, the shape being preset using the position of the target as a reference position.

18. The method according to claim 10, wherein the detecting the first target includes detecting a face or an upper part of a body to acquire the position of the target.
